(19) United States
(12) Patent Application Publication
(10) Pub. No.: US 2025/0335267 A1
(43) Pub. Date: Oct. 30, 2025

(54) METHODS FOR POWER MANAGEMENT IN A DECLARATIVE WORKLOAD ENVIRONMENT

(71) Applicant: Dell Products L.P., Round Rock, TX (US)

(72) Inventors: BRADLEY K. GOODMAN, Nashua, NH (US); ERIC JOSEPH BRUNO, Shirley, NY (US); KIRK ALAN HUTCHINSON, Londonderry, NH (US)

(21) Appl. No.: 18/646,585

(22) Filed: Apr. 25, 2024

(51) Int. Cl. G06F 9/50

(52) U.S. Cl. CPC G06F 9/5094; G06F 9/5038

(57) ABSTRACT

Methods and systems for manage operation of endpoint devices are disclosed. To manage the operation of endpoint devices, management systems may monitor and update the state of the endpoint devices. When differences between the actual and configured states of an endpoint device are identified, actions to confirm the actual state to the configured state may be identified. The identified actions may be scheduled for performance based on declaratively defined maintenance windows, operational windows, and/or other factors.

### FIELD

Embodiments disclosed herein relate generally to device management. More particularly, embodiments disclosed herein relate to managing power consumed by devices.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2D show data flow diagrams in accordance with an embodiment.

FIGS. 2E-2F show diagram illustrating operation of a system in accordance with an embodiment.

FIGS. 3A-3D show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for distributed management of the operation of endpoint devices. To manage the operation of endpoint devices, a system may include any number of management systems. The management systems may be tasked with managing the operation of the endpoint devices.

To manage the operation of the endpoint devices, the management entities may generate and distribute state updates (e.g., declarative statements). The endpoint devices may consume the state updates and attempt to conform their states to the states specified by the state updates (e.g., by selecting and performing actions to update actual states to match the states expressed by the management entities).

When state differences between the actual and configured states of endpoint devices are identified, actions may be selected to conform the actual state to the configured state (e.g., reduce differences). Once selected, the actions may be scheduled for performance based on a variety metrics to manage impacts on the computer implemented services provided by the endpoint devices.

To manage power consumption by the endpoint device, a combination of declaratively defined operational windows and power policies may be used. The declaratively defined operational windows may express periods of time when an endpoint device is expected to be able to provide certain services. The power policies may express how power is to be consumed by the endpoint device during and outside of the operational windows. The endpoint device may take into account both the operational windows and power policies when selecting and scheduling actions to be performed by the endpoint device.

By doing so, embodiments disclosed herein may facilitate distributed management of endpoint devices in distributed systems while services are provided by the endpoint devices. By scheduling performance of actions based on metrics, operational windows, and power policies, the endpoint devices may be updated while limiting impacts on provided services and meeting power consumption goals without needing to expressly define actions to be performed by the endpoint devices. Thus, embodiments disclosed herein may address, among others, the technical problem of limited resources in distributed systems through distributing authority over the endpoint devices (e.g., management systems may select desired states while endpoint devices may select actions to perform based on the selected states).

Accordingly, even if communication between an endpoint device and management system is lost, the endpoint device may still be able to independently take action to improve the likelihood that the operation of the endpoint device meets expectations expressed by the management system.

In an embodiment, a method for managing operation of an endpoint device is provided. The method may include identifying a difference between a configured state and an actual state; identifying, based on the difference and a power policy, at least one action; identifying, for a first action of the at least one action, a scheduling limitation based on an operational window for the endpoint device; performing, using the scheduling limitation, a scheduling process for the first action to obtain a schedule; updating operation of the endpoint device using the schedule and the at least one action to obtain an updated endpoint device; and providing computer implemented services using the updated endpoint device.

The scheduling limitation may include a required power state of the endpoint device.

The operational window may be declaratively defined. The power policy may specify a power state of the endpoint device as a function of declaratively defined operational windows of the endpoint device.

The at least one action, when performed, may be expected to reduce the difference. The difference may be based on a declaratively defined operation for the endpoint device, the declaratively define operation being keyed, at least in part, to the operational window.

The method may also include, prior to identifying the difference: obtaining, by a sideband component of the endpoint device and from an orchestrator having authority to manage the endpoint device, an update impacting a previous configured state of the endpoint device; making, by the sideband component, a determination regarding whether the update requires a state analysis by the endpoint device; and in an instance of the determination where the update requires the state analysis: waking up the endpoint device from a low power state in which the endpoint device is unable to identify the difference.

The difference may be due to the update, the update may change the previously configured state to the configured state, and the actual state may change the previously configured state when the difference is identified.

The sideband component may include a management controller hosted by the endpoint device, and the endpoint device may include hardware resources distinct from and managed by the management controller. For example, the management controller may control the operation of the hardware resources via out of band/sideband communications.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

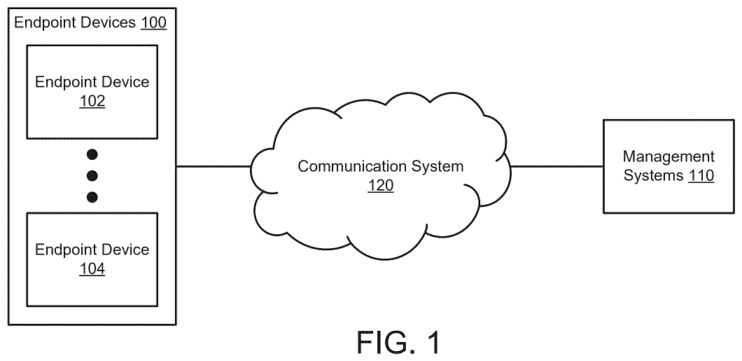

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, and/or any other type of service that may be implemented with a computing device.

To provide the computer implemented services, the system include endpoint devices 100. Each endpoint device (e.g., 102, 104) may provide similar and/or different computer implemented services, and may provide the computer implemented services independently and/or in cooperation with other endpoint devices.

To provide the services, each of endpoint devices 100 may host computer code that when executed causes the endpoint devices to provide corresponding computer services. Additionally, the hardware and/or software configurations of endpoint devices 100 may impact the manner in which the computer implemented services are provided.

For example, modifying the computer code hosted by endpoint devices 100 may cause endpoint devices 100 to provide different types of computer implemented. The computer code may correspond to applications, virtual machines, containers, etc.

However, when the actual state of an endpoint device differs from a desired state, then the endpoint device may be unable to provide desired computer implemented services, or may do so in an undesirable manner. For example, to provide computer implemented services, an endpoint device may host an application. Overtime, the application may be updated to correct for security issues, bugs, and/or other factors. If the copy of the application hosted by the endpoint device is not similarly updated, then the operation of the application may, for example, subject the endpoint device to malicious attacks, fail to operate as expected, and/or may otherwise undesirably impact the provided computer implemented services.

Further, during operation, endpoint device may consume power. If the endpoint devices are operating but not providing useful services, then the expenditure of power may not contribute to desired outcomes for a system.

In general, embodiments disclosed herein may provide methods, systems, and/or devices for managing the services provided by endpoint devices 100. To manage the services provided by endpoint devices, the endpoint devices and requesting entities may implement a state management model. The state management model may allow the endpoint devices to conform an actual state to a desired state.

The state management model may track three different states ascribed to endpoint devices. These three states may include a desired state, a configured state, and an actual state. The desired state may reflect a requesting entity's desired state for an endpoint device. The configured state may reflect the state that an endpoint device is attempting to achieve. The actual state may reflect the state of the endpoint device as it exists.

To resolve differences between the actual state and configured/desired states, actions may be scheduled to be performed. The actions may, when performed, resolve or reduce the differences.

To ascertain when to schedule the performance of the actions, a variety of factors may be taken into account including, for example, prerequisites for the actions, impacts on operation of endpoint devices when the actions are performed, resource use in performing the actions, time required to perform the actions, a current adequacy level of the endpoint device, and maintenance windows for performing maintenance on the endpoint devices. Once scheduled, the actions may be performed to address the identified differences.

To manage power consumption when providing services, declaratory statement regarding the operating states of the endpoint devices may be used to limit power consumption. Power policies may be keyed to these declaratory statements thereby allowing the endpoint devices to dynamically select and perform imperative actions to effectuate the goals outlined by the declarative statements.

By doing so, the functionality of endpoint devices in a distributed system may be managed with reduced impact on the ability of the endpoint devices to provide desired computer implemented services.

To provide the above noted functionality, the system of FIG. 1 may include endpoint devices 100 and management systems 110. Each of these components is discussed below.

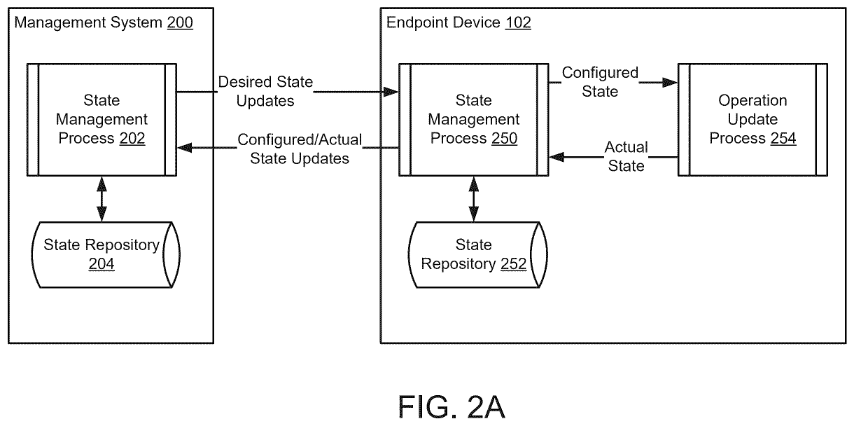

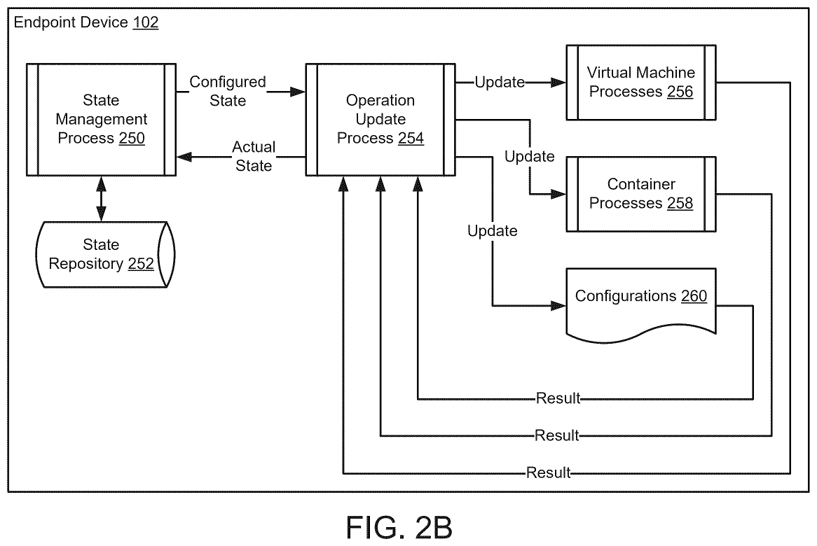

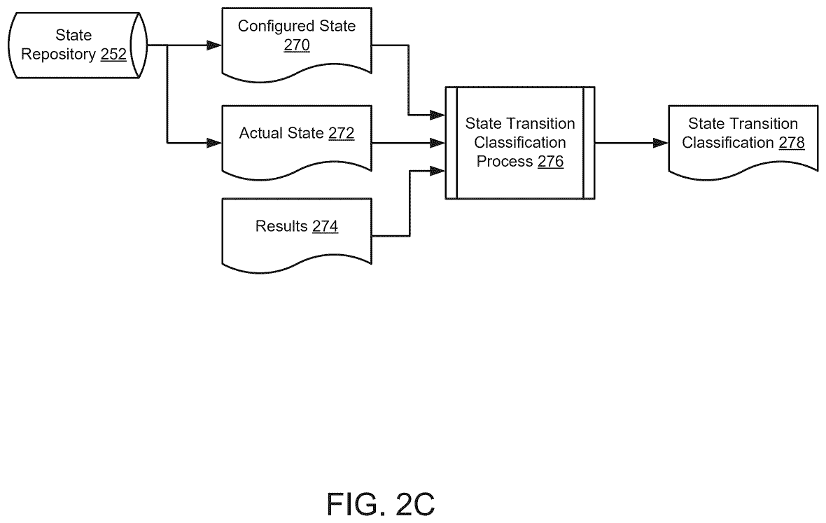

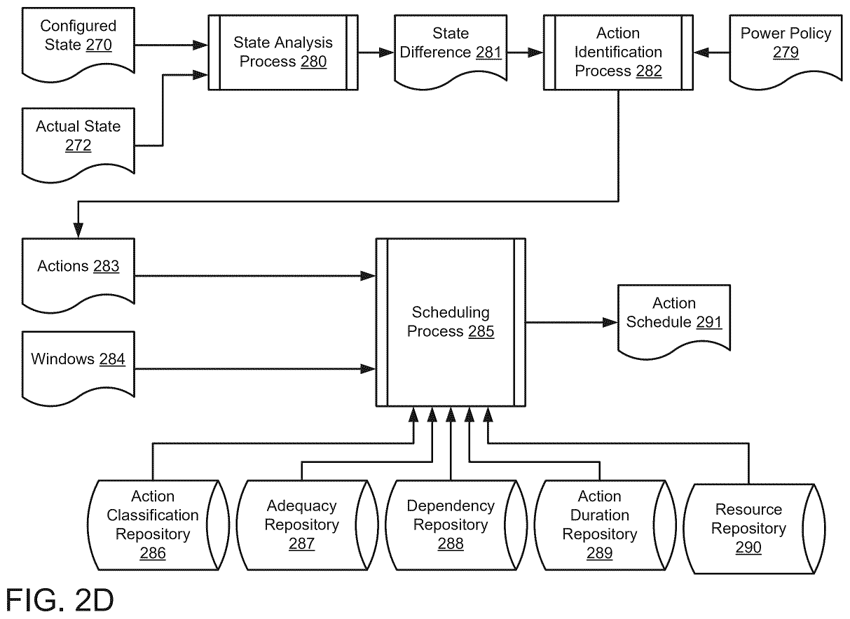

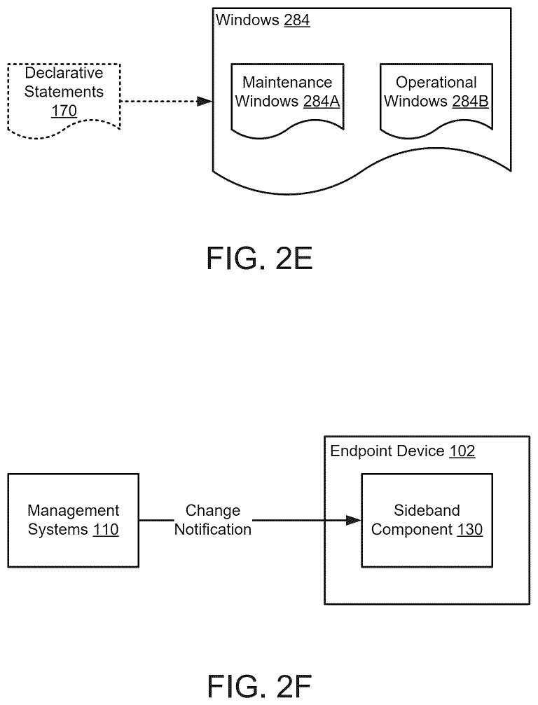

Endpoint devices 100 may provide computer implemented services. To provide the computer implemented services, endpoint devices 100 may manage its states using a state management model. When managing its state, an endpoint device may (i) obtain desired state updates from management systems 110 and/or other components, (ii) evaluate the desired state updates based on whether the desired state updates are based on an accurate understanding of the states of the endpoint device, (iii) for positively evaluated desired state updates, update its states based on the desired state updates, and/or (iv) attempt to update its operation based on its states by scheduling performance of corresponding actions. Refer to FIGS. 2A-2E for additional details regarding updating the operation of endpoint devices 100.

Management systems 110 may manage the computer implemented services provided by endpoint devices 100. To do so, management systems 110 may (i) attempt to track the state of endpoint devices 100 based on a state model (e.g., that tracks the desired, configured, and actual states of endpoint devices 100, as well as state transition progress), (ii) generate and provide desired state updates to endpoint devices 100 (e.g., depending on the computer implemented services desired by management systems 110 and/or other entities), and (iii) attempt to resolve state transitions delays impacting endpoint devices 100. Refer to FIGS. 2A-2D for additional details regarding management of endpoint devices 100 by management systems 110.

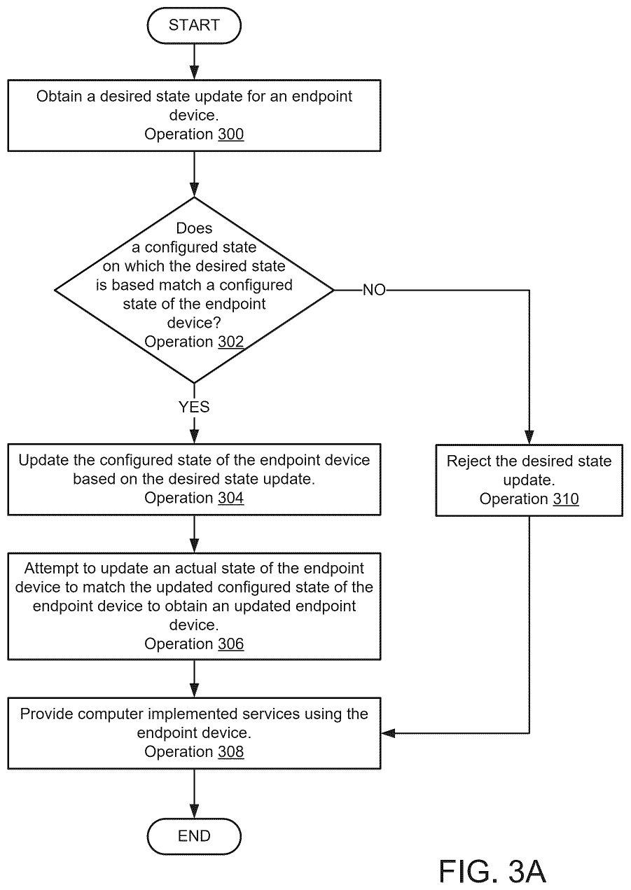

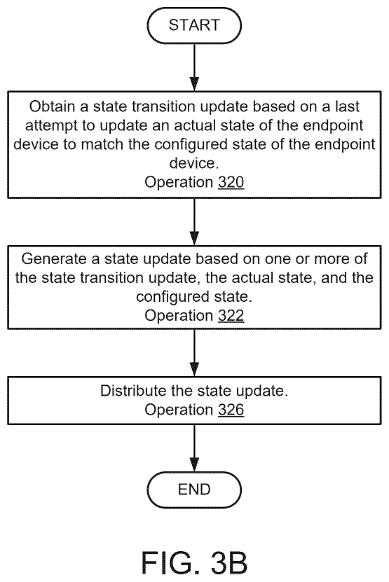

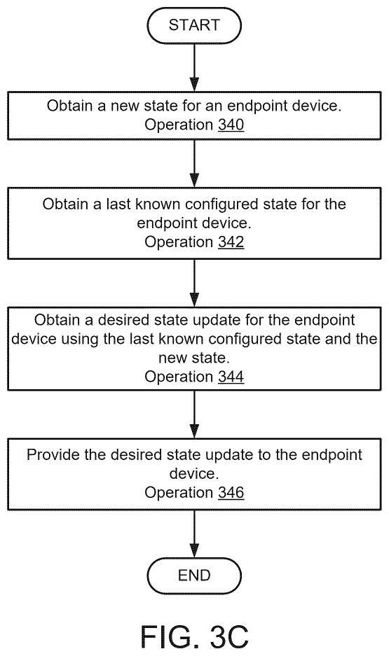

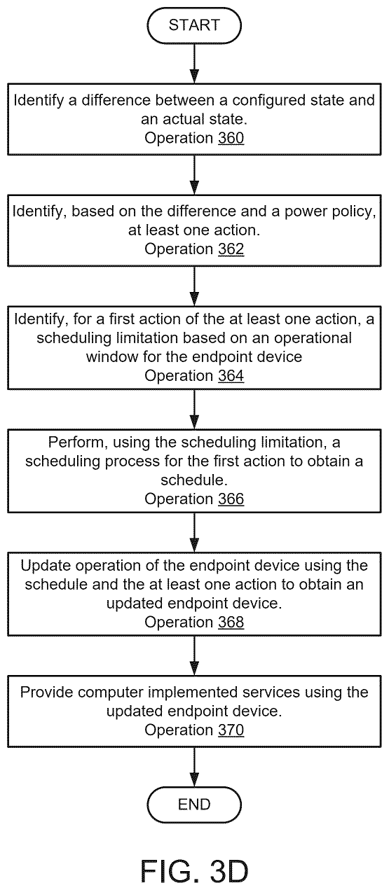

When providing their functionality, any of (and/or components thereof) endpoint devices 100 and/or management systems 110 may perform all, or a portion, of the methods and flows illustrated in FIGS. 2A-3D.

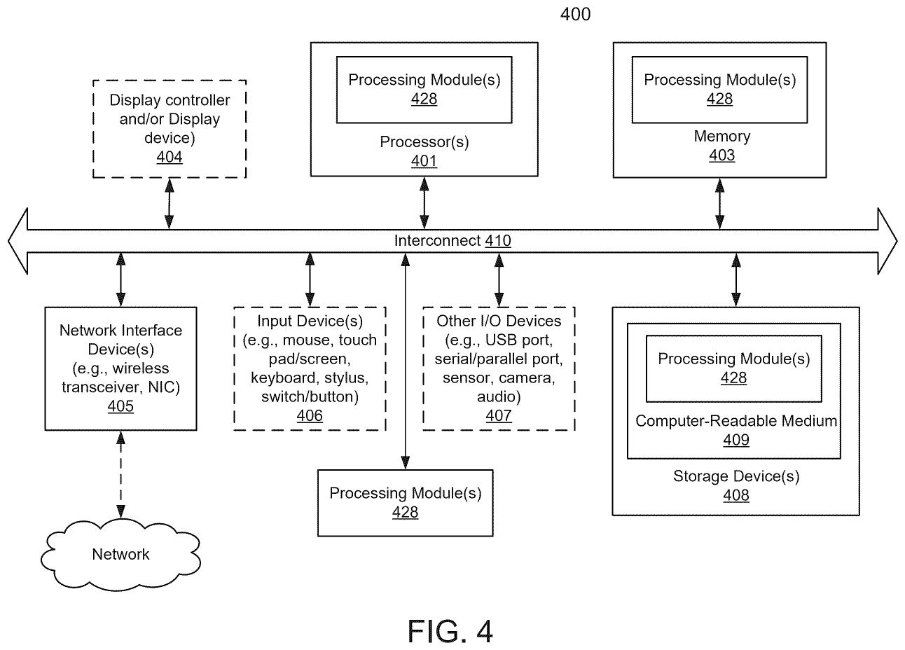

Any of (and/or components thereof) endpoint devices 100 and management systems 110 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 120. In an embodiment, communication system 120 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2D. In these diagrams, flows of data and processing of data are illustrated using different sets of shapes. A first set of shapes (e.g., 270, 272, etc.) is used to represent data structure, a second set of shapes (e.g., 202, 250, etc.) is used to represent processes performed using and/or that generate data, and a third set of shapes (e.g., 204, 252, etc.) is used to represent large scale data structures such as databases.

Turning to FIG. 2A, a first data flow diagram in accordance with an embodiment is shown. The first data flow diagram may illustrate data used in and data processing performed in state management of endpoint devices.

To manage the state of an endpoint device (e.g., 102), management system 200 (e.g., which may be similar to any of management systems 110) may attempt to track the states of endpoint devices, and provide desired state updates to the endpoint device.

To attempt to track the state of endpoint device 102, management system 200 may solicit state updates from endpoint device 102. To do so, management system 200 may utilize any system through which state updates for endpoint device 102 may be obtained. For example, endpoint device 102 may implement a subscription service for state updates.

The state updates obtained by management system 200 may include configured state updates and actual state updates. These updates may indicate the configured and actual state of endpoint device 102, respectively.

When such updates are obtained by management system 200, state management process 202 performed by management system 200 may ingest and process the state updates to update a model of the states of endpoint device 102 maintained by management system 200. The state model may attempt to track the desired, configured, and actual state of endpoint device. However, the configured and actual state from the model may become stale over time.

To attempt to modify the computer implemented services provided by endpoint device 102, state management process 202 may generate and provide desired state updates to endpoint device 102. The desired state updates may express (i) a new state for endpoint device 102 as desired by management system 200, and (ii) an understanding of the configured and/or actual state of endpoint device 102 as understood by management system 200.

For example, a desired state update may specify a change to an existing configured state of endpoint device 102 as understood by management system 200. However, because the configured state of endpoint device 102 as understood by management system 200 may be stale, the resulting desired state update may be incongruent with respect to the configured and/or actual state of endpoint device 102.

Management system 200 may generate desired state updates based on (i) requests from users, (ii) information regarding attempted state transitions by endpoint devices (e.g., to resolve failed attempts), and/or on types of information. The desired state updates may be provided to endpoint device 102 by sending them via one or more messages.

Management system 200 may store information regarding the state and attempted state transitions of endpoint device 102 in state repository 204. State repository 204 may be implemented using a database or other data structure, and may include information regarding the states/attempted state transitions of any number of endpoint devices.

Once provided to endpoint device 102, state management process 250 may ingest the desired state updates. If the desired state updates express a configured state for endpoint device 102 that is consistent with the configured state of endpoint device 102 as understood by endpoint device 102, then endpoint device may deem the desired state updates as being valid and implement them. The desired state updates not deemed as valid may be rejected. In this manner, only management systems that have a consistent understanding of the configured state of endpoint device 102 may be able to modify the states of endpoint device 102. Consequently, incongruencies between state updates may be resolved through rejection of some of the state updates.

If rejected, state management process 250 may send information regarding the configured and/or actual state to management system 200.

If deemed valid, state management process 250 may update its configured state to reflect the desired state of management system 200. Once updated, state management process 250 may initiate propagation of the updated configured state to operation update process 254.

Operation update process 254 may ingest the updated configured state and initiate changes in endpoint device 102. The changes may be intended to update the actual state of endpoint device 102 to match the updated configured state.

The changes may include, for example, adding or removing instances of software entities (e.g., executing applications, drivers, operating systems, etc.), modifying configurations of hardware components and/or software entities, and/or otherwise modifying the manner in which endpoint device 102 operates.

The changes may be selected and implemented by an automation engine. The automation engine may use a set of rules (e.g., set by a subject matter expert) or other criteria to identify actions that are likely to modify the actual state of endpoint device 102 to match the configured state of endpoint device 102. Refer to FIG. 2D for additional details regarding selection, scheduling, and performance of such actions.

As changes are made by operation update process 254 (e.g., via an automation engine), the actual state of endpoint device 102 may be updated. For example, the actual state may be provided to state management process 250, which may update the representation of the actual state as stored in state repository 252 as part of a state model.

In contrast to the state model maintained by management system 200 (which may attempt to track the desired, configured, and actual state), the state model maintained by endpoint device 102 may only track the configured and actual states of endpoint device 102. For example, if desired state updates are found to be valid, then the configured state may be updated. Otherwise, information regarding desired states may not be retained by endpoint device 102.

In addition to information regarding changes in the actual state of endpoint device 102, operation update process 254 may also monitor attempts to update the actual state to match the configured state. Information regarding these attempts may be used to establish a classification for the transition of an actual state to match an updated configured state.

For example, while the actual state does not match the configured state, information regarding actions performed to modify the actual state to match the configured state may be recorded and used to identify whether (i) the actual and configured state match (e.g., classified as a successful state transition), (ii) the actual and configured state do not match but continued progress is made (e.g., classified as an in process state transition), and (iii) the actual and configured state do not match but no progress is being made (e.g., classified as a failed state transition). No progress may be made when, for example, an error occurs, a condition is encountered that is not addressed by the rules used to select actions to perform to modify the actual state, and/or for other reasons. In other words when a failed state transition is identified, it is expected that no additional progress will be made in matching the actual state to the configured state unless an outside intervention is performed. Refer to FIG. 2B for additional details regarding modifying the actual state to match the configured state of endpoint device 102.

When state updates are provided by state management process 250 to other entities, the state updates may include information regarding the actual and configured state as well as the classification for any current state transition that is being carried out. In this manner, entities such as management system 200 may obtain additional information upon which new desired state updates may be generated. For example, in the event that a state transition is classified as a failed state transition, management system 200 may identify which portions of the configured state of endpoint device 102 that endpoint device 102 is unable to update the actual state to match. Management system 200 may use this information to generate a desired state update that that changes these portions of the configured state such that endpoint device 102 will be more likely to be able to transition the actual state to match the configured state.

Turning to FIG. 2B, a second data flow diagram in accordance with an embodiment is shown. The second data flow diagram may illustrate data used in and data processing performed in modification of the actual state of endpoint device 102 to match the configured state.

To update the actual state of endpoint device 102, operation update process 254 may invoke use of an automation engine to select actions to perform. These actions may include making various updates to virtual machine processes 256, container processes 258, configurations 260, and/or other aspects regarding the operation of endpoint device 102. Refer to FIG. 2D for additional details regarding selection, scheduling, and performance of such actions to update the operation of endpoint device 102.

Virtual machine processes 256 may include process performed by virtual machine and processes performed to support execution of virtual machines. The virtual machines may facilitate all or a portion of the computer implemented services provided by endpoint device 102. Virtual machine processes 256 may be updated by (i) instantiating or terminating virtual machine instances, (ii) modifying resource allocations to virtual machine instances, and/or perform other actions to modify the operation of virtual machines.

Container processes 258 may include process performed by containers and processes performed to support execution of containers. The containers, like the virtual machines, may facilitate all or a portion of the computer implemented services provided by endpoint device 102. Container processes 258 may be updated by (i) instantiating or terminating container instances, (ii) modifying resource allocations to the container instances, and/or perform other actions to modify the operation of containers.

Configurations 260 may include configuration settings for various hardware components and/or software entities. Configurations 260 may be updated by modifying the content of the data structures, invoking functions of corresponding applications to modify configuration settings that may be protected from external modification, and/or via other methods.

While illustrated with respect to virtual machine and container processes, it will be appreciated that processes corresponding to other types of software entities may be similarly updated.

When any of the processes 256, 258 and configuration 260 are updated by performance of various scheduled actions, the results from the updates may be obtained and used to identify changes to the actual state of endpoint device 102. For example, results reflecting successfully instantiated or terminated virtual machines/containers as part of updates made by operation update process 254 may be used to identify an updated actual state of endpoint device 102. Consequently, the actual state provided to state management process 250 may be an accurate reflection of the current state of endpoint device 102.

The results may also be used to classify attempted state transitions performed by endpoint device 102.

Turning to FIG. 2C, a third data flow diagram in accordance with an embodiment is shown. The third data flow diagram may illustrate data used in and data processing performed in classifying attempted state transitions.

To classify a state transition, state transition classification process 276 may be performed. During transition classification process 276, configured state 270, actual state 272, and results 274 may be ingested and used to obtain state transition classification 278.

To obtain state transition classification 278, results 274 may be compared to actual state 272 to identify whether any progress towards conforming actual state 272 to configured state 270 has been made by virtue of one or more actions that were performed and caused results 274 to be generated. For example, if results 274 do not indicate that actual state 274 has changed, then it may be concluded that no progress has been made in conforming actual state 272 to configured state 270. The number of actions performed without progress being made may be compared to a number of actions to ascertain whether to classify the attempt as being in-progress (e.g., not exceeding the number) or failed (e.g., exceeds the number). The number may be a threshold that may be prescribed ahead of time, dynamically updated over time, etc. Additionally, the threshold may vary depending on the type of actions being performed.

For example, some types of actions (e.g., attempts made to instantiate software) may have lower numbers as basis for comparison than other types of actions (e.g., attempts to resolve performance level issues such as rates of processing data).

The resulting state transition classification 278 may be based on whether progress has been made (e.g., in progress), or not (e.g., failed), or if the actual state 272 is conformed to configured state 270 (e.g., successful).

Thus, using the data flow illustrated in FIG. 2C, classifications for state transition may be obtained. The state transitions may be provided along with information regarding states to other entities so that the other entities may make better decisions regarding how to construct desired state updates. Consequently, endpoint devices may be more likely to be able to conform actual states to configured states thereby causing the endpoint devices to provide desired computer implemented services.

Turning to FIG. 2D, a fourth data flow diagram in accordance with an embodiment is shown. The fourth data flow diagram may illustrate data used in and data processing performed in identifying, scheduling, and performing actions to modify an actual state based on a configured/desired state.

To identify, schedule, and perform the actions, information regarding configured state 270 (and/or a desired state) and actual state 272 may be obtained. Configured state 270 and actual state 272 may be ingested by state analysis process 280 to attempt to identify differences between these two states. The differences occur, for example, due to changes made to configured state 270, due to drift of actual state 272, and/or for other reasons.

For example, the changes may include changes to declaratively defined windows. The declaratively defined windows may include, for example, maintenance windows and operational windows. The maintenance windows may be periods of time when maintenance activity expected to be performed. The operational windows may be periods of time when an endpoint device is expected to be operable for the computer implemented services that it provides. For example, an endpoint device may be an edge device used in a retail environment with predefined hours of operation. In such a scenario, an operational window may be defined to coincide with the hours of operation.

During state analysis process 280, the states may be analyzed to identify such differences. To do the analysis, for example, complementary portions of configured state 270 and actual state 272 may be compared to each other to identify whether there are differences.

For example, a portion of configured state 270 may indicate that an application is to be hosted by an endpoint device and be of version 2.0. However, a complementary portion of actual state 272 may indicate that while the application is installed, the version of the installed application is version 1.3. This difference in version number may be identified as a difference via state analysis process.

Any number of such differences may be identified and aggregated as state difference 281. Once obtained, state difference 281 may be ingested by action identification process 282.

During action identification process 282, any number of actions 283 may be identified. Actions 283 may be selected to reduce and/or eliminate the differences and otherwise conform operation of the endpoint device to the declaratively defined configured state 270. The actions may be identified via any process. For example, sets of subject matter expert derived rules or associations that relate differences to actions may be utilized. Thus, different types of differences may be used as keys to identify actions. Any difference may result in the addition of any number of actions to actions 283.

For example, returning to the software version difference example, the following example actions may be added to actions 283 based on this difference: (i) downloading a copy of the version 2.0 software, (ii) pausing/terminating execution of the application, (iii) installing the updated version of the software, and (iv) restarting execution of the updated application.

In an embodiment, one or more power policies (e.g., 279) are used to select at least some of the actions. The power policies may define how the endpoint device is to operate based on the operational windows with respect to power consumption. For example, the power policies may specify that outside of the operational windows, the power consumption by the endpoint device is to be reduced (e.g., enter a low power or powered off state). Thus, power policy 279 may be used to select action (e.g., depowering, setting timers for when to power back up) that result in compliance with the power policy. The actions may include, for example, depowering or reducing power consumption out of the operation windows, and powering up during the operational windows.

However, when in a low or no power space, an endpoint device may be unable to process changes in desired state. As will be discussed in greater detail with respect to FIGS. 2E-2F, the endpoint device may utilize sideband components to modify its operation should impactful desired state updates be obtained while the endpoint device is in a reduced power state.

Once actions 283 are obtained, scheduling process 285 may be performed. During schedule process 285, the actions may be scheduled for performance. The scheduled may be stored as action schedule 291. The action schedule may be used, for example, by an automation framework that performs actions at different times indicated by action schedule 291.

To identify when to perform the actions, scheduling process 285 may ingest windows 284, and information from and/or based on action classification repository 286, adequacy repository 287, dependency repository 288, action duration repository 289, and resource repository 290. Each of these data structures is discussed below.

Windows 284 may define maintenance windows for an endpoint device, operation windows for the endpoint devices, and/or other periods of time which have been declaratively defined (e.g., as part of configured state 270). The windows may be declaratively defined. Each window may have a start and a stop time. Refer to FIG. 2E for additional details regarding operational windows.

Each maintenance window of windows 284 may also be tagged. The tags applied to a maintenance window may indicate, for example, the types of actions that are allowed and not allowed to be performed during each window, which types of applications or other entities hosted by an endpoint device are allowed to be disrupted (e.g., paused, terminated, or otherwise modified by actions), constraints on resource use for actions during maintenance windows, and/or other limits on the use of windows.

Each maintenance window may also have characteristics such as type, name, etc. These characteristics may be further used to discriminate actions that may or may not be performed during the maintenance window. For example the window characteristics may be used to schedule, a general background operation, that can run in-conjunction with an application, but should be run during a known-period of reduced activity; maintenance operations like an upgrade, which impacts real-world availability, and need be run only during specifically designated “maintenance window”; an “unusual”, one-time imperative action that must be done “right now”, or scheduled for one, specific time in the future; and a set of actions that must be especially coordinated to run in-tandem across several endpoints, which may normally do not share common maintenance windows.

Action classification repository 286 may include classifications for or information usable to identify classifications for the actions. The actions may be classified as either being disruptive or non-disruptive. A disruptive action may be one that may impact operation of existing applications hosted by an endpoint device. A non-disruptive action may be one that may consume resources but that does not disrupt the operation of other applications.

To make the identifications, information from dependency repository 288 may also be used. Dependency repository 288 may include information regarding any actions that must have been completed prior to performance of another action. For example, downloading of a copy of software may be a dependency (e.g., a prerequisite) for installing the software. The information from action classification repository 286 may indicate which actions from actions 283 may be disruptive, the information from dependency repository 288 may identify which other actions may need to be performed for the actions to be performed, and the dependencies may be screened to see if any are disruptive. Thus, using the information in these two repositories, actions from actions 283 may be classified as either disruptive or non-disruptive. These classifications may be used to identify whether an action must be scheduled within a maintenance window, or may be schedule outside of a maintenance window.

Adequacy repository 287 may include information usable to ascertain whether a current operation of an endpoint device is proper, adequate, or inadequate. Being classified as proper indicates that the endpoint device is running all jobs as intended. Being classified as adequate indicates that jobs are running sufficiently well such that immediate action isn't required, but that there is some difference being ideal and actual performance. Inadequate may indicate that the jobs performed by the endpoint device do not meet minimum expectations.

Adequacy repository 287 may include any type of criteria by which to judge the adequacy of the current operation of the endpoint device. For example, the criteria may include minimum through put, maximum durations of time to complete jobs, etc. The adequacy classification ascribed to an endpoint device may be used to decide how soon a particular action needs to be scheduled, whether actions should be performed outside of maintenance windows, etc. For example, when classified as inadequate, performance of the actions may be prioritized over continued performance of jobs. In contrast, when classified as adequate, continued performance of the jobs may be prioritized over performance of the actions that are performed to address the state differences. While classified as adequate, the actions may be restricted for performance only during maintenance windows, while the actions may be scheduled for performance outside of the maintenance windows while classified as inadequate.

Adequacy repository 287 may also include criteria linked, for example, to the actual state of the endpoint device. For example, the criteria may specify different version ranges of an application that are considered proper, adequate, and inadequate. Thus, a combination of performance and state may be taken into account when ascribing a level of adequacy to the endpoint device. It will be appreciated that the criteria for adequacy may, for example, be part of the configured state/goal state.

Action duration repository 289 may include information regarding estimated durations of time for performance of an action. The time durations may be used to select when to schedule actions in maintenance windows so that disruptive actions are not performed outside of the maintenance windows.

The information stored in action duration repository 289 may be based on, for example, user input (e.g., a user may provide the estimate), historical information (e.g., past performances of actions where the time has been tracked), formulas/algorithmic analysis (e.g., may analyze computing resource cost and available resources), and/or via other methods.

Resource repository 290 may include information regarding estimated resource consumption for performance of an action. The resources may relate, for example, to computing resources (e.g., processing cycles, memory/storage space, communication bandwidth, etc.), power (e.g., electricity), thermal dissipation, and/or other resources that may be consumed by an endpoint device by virtue of power consumption.

Resource repository 290 may further include information regarding resources consumption limits placed on the actions. For example, the endpoint device, the action itself, and/or other entities may place resource consumption limits on actions.

Resource repository 290 may also include information reported by endpoint devices regarding the available resources for use in performing the actions.

The information from resource repository 290 may be used to select when to schedule action so that the performance of the operations does not deprive the endpoint device of sufficient resources to provide the desired computer implemented services.

The information in any of the repository (e.g., 286-290) may be defined by subject matter experts, may be based on historic analysis of operation of endpoint devices, and/or may be obtained via other methods.

Once information for a given process is obtained from the repositories, scheduling process 285 may use the information to schedule performance of the actions. The scheduling process may utilize any type of optimization technique (e.g., global/local) to select an optimal time for performance based on constraints. The constraints may include, for example, (i) that all of actions 283 need to be scheduled, (ii) that all prerequisites for an action need to be completed prior to performance of the action, (iii) that disruptive actions only be scheduled in maintenance windows in which the disruptive actions are estimated to be completed before the end of the maintenance windows, (iv) that none of the limits imposed on windows (e.g., specified by tags/metadata) are violated by a scheduling (e.g., cannot schedule a type of action in a maintenance window that is tagged as only being eligible for other types of actions), and (v) no action may be scheduled if the action is incomplete and deemed to not be moving toward completion (e.g., an error has occurred, an administrator may be notified and/or other action may be performed to address the error).

The resulting times for performing each of actions 283 may be stored in action schedule 291. Once scheduled, action schedule 291 may be used by an automation framework to perform the actions. Performance of the actions may update actual state 272, which may result in additional actions being schedule for performance if actual state 272 continues to be different from configured state 270.

However, in some cases, based on the constraints, an action may not be able to be scheduled (e.g., may take too long for any maintenance windows). In such a scenario, an error may be identified and various actions may be performed to address the error. The actions may include sending various notifications, pausing certain services, etc.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Turning to FIG. 2E, a diagram illustrating windows 284 in accordance with an embodiment is shown. Windows 284, as discussed above, may define various maintenance windows 284A, operational windows 284B, and/or other types of windows. The windows may be declaratively defined via declarative statements 170 from the configured state for the endpoint device. For example, a management entity may make such declarative statements as part of an expressed desired state of the endpoint device. The declarative statements may express starts for, stops for, and types of windows.

Power policies that govern the endpoint devices may be keyed to these windows. For example, the power policies may indicate, based on at least the operational windows, the power states of the hardware components of the endpoint device during and outside of the operational windows. When selecting and scheduling actions to conform an actual state to a configured state, the actions may be selected to meet such policies.

In some cases, conflicts may arise between power policies and activity that may need to be performed to conform actual states to configured states. In such scenarios, conformance of the actual state to the configured state may be prioritized. For example, if an actual state of an endpoint device includes an application at version 1.3 and a configured state includes an application at version 2.0, then an action to download the version 2.0 software may be identified. Because such an operation is unlikely to be disruptive, it may be scheduled outside of maintenance windows. However, operational windows may indicate that the endpoint device is to be depowered outside of a maintenance window. To resolve this conflict (e.g., need to schedule an action while also needing to depower the endpoint device), scheduling and performance of the action may be prioritized over depowering the endpoint device. Consequently, actions to depower the endpoint device may be shifted in time so as to allow the action to download the software to be performed.

Turning to FIG. 2F, a diagram illustrating an interaction between management systems 110 and endpoint device 102 in accordance with an embodiment is shown. As discussed above, from time to time, the hardware resources (e.g., in-band resources) may be depowered based on operational windows. During such times, the hardware resources and corresponding software may be unable to process state changes specified by management systems 110. Thus, if such changes are received by the hardware resources during these periods of time, the hardware resources may be unable to confirm the actual state of endpoint device 102 to the desired state.

To reduce improve compliance of the actual state to the desired state, endpoint device 102 may host sideband component 130. Sideband component 130 may be implemented using, for example, an out of band management controller that operates independently from and manages operation of the hardware resources of endpoint device 102. While the hardware resources of endpoint device 102 are in a lower powered state and/or may be unable to process state updates from management system 110, sideband component 130 may obtain and process the change notifications from management systems 110 to identify whether currently scheduled actions (e.g., being depowered for some duration of time) are likely to cause the actual state of endpoint device 102 to remain out of compliance with a desired/configured state expressed by management systems 110.

For example, sideband component 130 may read the action schedule and determine whether (i) the hardware resources are active, and (ii) whether the express desired state requires immediate or future action by endpoint device 102 prior to when endpoint device 102 is scheduled to perform action to power back up or otherwise enter a state in which it may process the state update.

If sideband component 130 identifies that the change notification should be acted upon by endpoint device 102 prior to when it will do so based on the scheduled actions, then sideband component 130 may initiate performance of actions to cause endpoint device 102 to act on the change notification. For example, sideband component 130 may initiate performance of actions to repower the hardware resources of endpoint device 102.

Thus, by doing so, endpoint device 102 may, while in a low power state, be less likely to remain out of compliance with desired/configured states while still reducing power consumption (e.g., thereby complying with the power policies). For example, sideband component 130 may be implemented with a low power system on a chip that consumes much less power than the hardware resources.

As discussed above, the components of FIG. 1 may perform various methods to manage the operation of endpoint devices. FIGS. 3A-3D illustrate methods that may be performed by the components of the system of FIG. 1. In the diagrams discussed below and shown in FIGS. 3A-3D, any of the operations may be repeated, performed in different orders, and/or performed in parallel with or in a partially overlapping in time manner with other operations.

Turning to FIG. 3A, a flow diagram illustrating a method for providing computer implemented services in accordance with an embodiment is shown. The method may be performed by any of endpoint devices 100, management systems 110, and/or other components of the system shown in FIG. 1.

Prior to operation 300, an endpoint device may obtain a configuration state and update its operation to conform the actual state of the endpoint device to match the configured state. Information regarding the actual and/or configured state may be distributed to any number of management systems and/or other devices.

At operation 300, a desired state update for the endpoint device is obtained. The desired state update may be obtained by reading it from storage, receiving it via a message from another devices, by generating it, and/or via other methods. The other device may be a management system and/or another device. The other device may have a consistent or stale view of the configured and/or actual state of the endpoint device.

At operation 302, a determination is made regarding whether a first configured state on which a desired state specified by the desired state update matches the configured state of the endpoint device. The determination may be made by comparing the first configured state to the configured state of the endpoint device. The comparison may indicate whether the two match.

The determination may also be made using criteria that define when a match is made. The criteria may allow for variance of the first configured state from the configured state of the endpoint device. The amount of acceptable variance may be defined, for example, on a percentage basis or other criteria.

The first configured state may be specified directly by the desired state update (e.g., specifies the state) or indirectly. To indirectly specify the first configured state, the desired state update may include information regarding, for example, an end goal state, changes between the first configured state and the end goal state, and/or the first configured state.

If the first configured state matches the configured state of the endpoint device, then the method may proceed to operation 304. Otherwise, the method may proceed to operation 310.

At operation 304, the configured state of the endpoint device is updated based on the desired state update. The configured state may be updated by modifying the configured state to match all, or a portion, of the first configured state specified by the desired state update.

At operation 306, an attempt to update the actual state of the endpoint device is made to match the updated configured state of the endpoint device to obtain an updated endpoint device. The attempt may or may not be successful. The attempt may be made by providing information regarding the updated configured state to an automation engine. The automation engine may select one or more actions to perform. The actions may include, for example, instantiation and/or termination of software entities (e.g., virtual machines, containers, etc.), modification of configuration settings, etc. The actions may be performed which may or may not conform the actual state of the endpoint device to the configured state.

If unsuccessful, additional actions may be performed to attempt to conform the actual state to the configured state. The number of times additional actions are selected and performed may be tracked. The number of times may be compared to criteria that may limit the number of attempts that may be made to conform the actual state to the configured state.

A state transition update may be obtained based on the attempt to update the actual state of the endpoint device. The state transition update may be obtained using the number of attempts that have been made as well as whether the actual state matches the configured state.

Once obtained, an endpoint side state update may be generated based on the state transition update, the updated configured state, the actual state, and, in an instance of the attempting to update where the actual state was successfully updated to obtain an updated actual state, the updated actual state. The endpoint side state update may be obtained by adding the aforementioned information to a data structure.

Once obtained, the endpoint side state update may be distributed to a control plane element, such as a management system, a manager of a management system, an intermediate element that may distribute the endpoint side state update to other entities, etc. The endpoint side state update may be distributed by providing a copy of and/or information regarding the endpoint side state update to the control plane element.

At operation 308, computer implemented services are provided using the endpoint device. The computer implemented services may include any number and type of services. The method may end following operation 308.

Returning to operation 302, the method may proceed to operation 310 following operation 302.

At operation 310, the desired state update is rejected. The desired state update may be rejected by discarding it without updating the configured state, by sending a notification to the entity that established the desired state, and/or by performing other actions.

Additionally, an endpoint side state update may be provided to the entity that generated the desired state update. By providing the entity with the endpoint side state update, the entity may update its understanding of the configured and/or actual state of the endpoint device.

Thus, using the method illustrated in FIG. 3A, embodiments disclosed herein may facilitate distributed management of endpoint devices by reconciling incongruent desired state updates. To reduce the likelihood of receiving incongruent desired state updates, endpoint devices may distribute information regarding their states.

Turning to FIG. 3B, a flow diagram illustrating a method for distributing state updates for endpoint devices in accordance with an embodiment is shown. The method may be performed by any of endpoint devices 100, management systems 110, and/or other components of the system shown in FIG. 1.

At operation 320, a state transition update based on a last attempt to update an actual state of the endpoint device to match the configured state of the endpoint devices is obtained. The state transition update may be obtained similarly to as described with respect to operation 306.

At operation 322, a state update is generated based on one or more of the state transition update, the actual state, and the configured state. The state update may be an endpoint side state update. The endpoint side state update may be generated by adding the aforementioned information to a data structure.

At operation 324, the state update is distributed. The state update may be distributed by providing a copy of the state update to one or more devices. The devices may include management systems (and/or other type of control plane entities), other endpoint devices, and/or other types of devices. The specific devices to which the state update is provided may be selected based on a distribution list. The distribution list may specify entities interested in state updates that include specific content (e.g., successful state transitions, failed state transitions, in-process state transitions, etc.). Thus, the entities to which state updates are distributed may vary over time. For example, a specific management entity tasked with managing failures in conforming actual states to configured states may be listed in the distribution list as only being interested in state updates that indicate failed and/or in-process state transitions.

The method may end following operation 326.

Using the method shown in FIG. 3B, embodiments disclosed herein may update a distributed understanding of the states of endpoint devices. Consequently, other devices may be able to accurately identify relevant changes that may be made to the state of the endpoint device.

Turning to FIG. 3C, a flow diagram illustrating a method for updates the states of endpoint devices in accordance with an embodiment is shown. The method may be performed by any of endpoint devices 100, management systems 110, and/or other components of the system shown in FIG. 1.

At operation 340, a new state for an endpoint device is obtained. The new state may be obtained by receiving user input regarding the new state, by reading the new state from storage, by receiving the new state from another device, and/or via other methods.

If input regarding the new state is received, the user input may reflect desired services to be provided to the user that provided the user input. The user input may be translated into the new state using a set of rules that defines states in terms of desired computer implemented services, and/or via other conversion mechanisms.

At operation 342, a last known configured state for the endpoint device is obtained. The last known configured state may be obtained by reading it from storage, by obtaining it from another device, and/or via other methods.

At operation 344, a desired state update for the endpoint device is obtained using the last known configured state and the new state. The desired state update may be obtained by populating a data structure with changes from the last known configured state to attain the new state, information regarding the new state, and/or information regarding the last known configured state. Thus, depending on the content of the data structure, the configured state as known by a requesting device (e.g., a management system, another endpoint device, etc.) may be either directly or indirectly specified by the content.

At operation 346, the desired state update is provided to the endpoint device. The desired state update may be provided by sending a copy of the desired state update to the endpoint device via a message, and/or via other mechanisms (e.g., publish/subscribe systems, through intermediate entities, etc.).

The method may end following operation 346.

Thus, using the method illustrated in FIG. 3C, desired state updates may be generated and provided to endpoint devices to update the computer implemented services provided by the endpoint devices.

Turning to FIG. 3D, a flow diagram illustrating a method for updating operation of an endpoint device in accordance with an embodiment is shown. The method may be performed by any of endpoint devices 100, management systems 110, and/or other components of the system shown in FIG. 1.

Prior to operation 360, an endpoint device may be in a low power state. While in the low power state, a management system may issue a change to the desired state of the endpoint device. A sideband component of the endpoint device may process the update and identify that the endpoint device should take action to process the update. Based on the identification, the sideband component may initiate performance of actions to repower the hardware resources of the endpoint device. Once repowered, the endpoint device may check the desired state, and, when verified as being trustworthy, update a configured state to match the desired state.

At operation 360, a difference between the configured state of an endpoint device and an actual state of the endpoint device is identified. The difference may be identified by comparing complementary portions of the actual and configured states. Any number of differences may be identified via the comparison. At least one difference may be, for example, a declaratively defined operational window for the endpoint device. For example, the operational window may be expanded, shifted in time, reduced in duration, etc.

At operation 362, at least one action is identified based on the difference and a power policy. The at least one action may be identified by, for example, (i) performing a lookup in a repository that includes actions associated with differences, (ii) using the power policy to identify how the hardware resources are to be powered during different times based on the operational window (e.g., power policy may be keyed to the operational window, and may define power states for the hardware resources in/out of the operation windows), (iii) selecting actions based on the identified power states, (iv) performing an algorithm using the differences that outputs the actions, and/or via other methods. Any number of actions may be identified based on the difference. Actions may be identified for each of the differences identified in operation 360.

At operation 364, a scheduling limitation for a first action of the at least one action is identified. The scheduling limitation may be identified by, for example, performing lookups in various repositories, analyzing operational windows, etc. The lookups may use the first action as a key, may use the operational window as limits on when the first action may be performed, etc. Refer to FIG. 2D for additional information regarding identifying information in repositories based on the first action.

Scheduling limitations may be identified for each of the actions of the at least one action.

At operation 366, a scheduling process for the first action is performed using the scheduling limitations to obtain a schedule. The scheduling process may be performed by performing an optimization process that uses the scheduling limitations as constraints. The optimization may also take into account available maintenance windows, operational windows, other actions that need to be scheduled, levels of disruptiveness of the actions, available computing resources to perform the actions, and/or other factors.

For example, during the optimization process, different periods of time may be established as potential times when an action may be performed. Each potential period of time may be disqualified and/or scored (e.g., using a scoring system that ascribes points to the scheduling limiting attributes) based on the scheduling limitations. For example, potential periods of time that do not coincide with an operational windows may receive low scores so that it is unlikely actions are scheduled outside of the operational windows. Periods of time having sufficiently high scores and/or not being disqualified may be eligible. The first action may be scheduled in one of the eligible slots, taking into account other actions that may also need to be scheduled.

At operation 368, operation of the endpoint device is updated using the schedule and the at least one action to obtain an updated endpoint devices. The operation may be updated by providing the schedule and the at least one action to an automation framework or otherwise causing the at least one action to be performed based on the schedule. Performance of the action may update operation of the endpoint device. Any number of such actions may be performed.

At operation 370, computer implemented services are provided using the updated endpoint device. The services may be provided by the operation of the updated endpoint device.

The method may end following operation 370.

Thus, using the method shown in FIG. 3D, actions may be scheduled and performed in a manner that manages the impact on the computer implemented services provided by endpoint devices.

Any of the components illustrated in FIGS. 1-2F may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of an endpoint device, the method comprising:
identifying a difference between a configured state and an actual state;
identifying, based on the difference and a power policy, at least one action;
identifying, for a first action of the at least one action, a scheduling limitation based on an operational window for the endpoint device;
performing, using the scheduling limitation, a scheduling process for the first action to obtain a schedule;
updating operation of the endpoint device using the schedule and the at least one action to obtain an updated endpoint device; and
providing computer implemented services using the updated endpoint device.

2. The method of claim 1, wherein the scheduling limitation comprises:
a required power state of the endpoint device.

3. The method of claim 2, wherein the operational window is declaratively defined.

4. The method of claim 3, wherein the power policy specifies a power state of the endpoint device as a function of declaratively defined operational windows of the endpoint device.

5. The method of claim 4, wherein the at least one action, when performed, is expected to reduce the difference.

6. The method of claim 5, wherein the difference is based on a declaratively defined operation for the endpoint device, the declaratively define operation being keyed, at least in part, to the operational window.

7. The method of claim 1, further comprising:
prior to identifying the difference:
obtaining, by a sideband component of the endpoint device and from an orchestrator having authority to manage the endpoint device, an update impacting a previous configured state of the endpoint device;
making, by the sideband component, a determination regarding whether the update requires a state analysis by the endpoint device; and
in an instance of the determination where the update requires the state analysis:
waking up the endpoint device from a low power state in which the endpoint device is unable to identify the difference.

8. The method of claim 7, wherein the difference is due to the update, the update changing the previously configured state to the configured state, and the actual state matching the previously configured state when the difference is identified.

9. The method of claim 7, wherein the sideband component comprises a management controller hosted by the endpoint device, and the endpoint device comprises hardware resources distinct from and managed by the management controller.

10. A non-transitory machine-readable medium having instructions stored therein, which when executed by at least one processor, cause first operations to be performed, the first operations comprising:
identifying a difference between a configured state and an actual state;
identifying, based on the difference and a power policy, at least one action;
identifying, for a first action of the at least one action, a scheduling limitation based on an operational window for an endpoint device;
performing, using the scheduling limitation, a scheduling process for the first action to obtain a schedule;
updating operation of the endpoint device using the schedule and the at least one action to obtain an updated endpoint device; and
providing computer implemented services using the updated endpoint device.

11. The non-transitory machine-readable medium of claim 10, wherein the scheduling limitation comprises:
a required power state of the endpoint device.

12. The non-transitory machine-readable medium of claim 11, wherein the operational window is declaratively defined.

13. The non-transitory machine-readable medium of claim 12, wherein the power policy specifies a power state of the endpoint device as a function of declaratively defined operational windows of the endpoint device.

14. The non-transitory machine-readable medium of claim 13, wherein the at least one action, when performed, is expected to reduce the difference.

15. The non-transitory machine-readable medium of claim 14, wherein the difference is based on a declaratively defined operation for the endpoint device, the declaratively define operation being keyed, at least in part, to the operational window.

16. The non-transitory machine-readable medium of claim 10, wherein the first operations further comprise:
prior to identifying the difference:
obtaining, by a sideband component of the endpoint device and from an orchestrator having authority to manage the endpoint device, an update impacting a previous configured state of the endpoint device;
making, by the sideband component, a determination regarding whether the update requires a state analysis by the endpoint device; and
in an instance of the determination where the update requires the state analysis:
waking up the endpoint device from a low power state in which the endpoint device is unable to identify the difference.

17. The non-transitory machine-readable medium of claim 16, wherein the difference is due to the update, the update changing the previously configured state to the configured state, and the actual state matching the previously configured state when the difference is identified.

18. The non-transitory machine-readable medium of claim 16, wherein the sideband component comprises a management controller hosted by the endpoint device, and the endpoint device comprises hardware resources distinct from and managed by the management controller.

19. An endpoint device, comprising:
a processor; and
a memory coupled to the processor to store instructions, which when executed by the processor, cause first operations to be performed, the first operations comprising:
identifying a difference between a configured state and an actual state;
identifying, based on the difference and a power policy, at least one action;
identifying, for a first action of the at least one action, a scheduling limitation based on an operational window for the endpoint device;
performing, using the scheduling limitation, a scheduling process for the first action to obtain a schedule;
updating operation of the endpoint device using the schedule and the at least one action to obtain an updated endpoint device; and
providing computer implemented services using the updated endpoint device.

20. The endpoint device of claim 19, wherein the scheduling limitation comprises:
a required power state of the endpoint device.
